(19) United States
(12) Patent Application Publication
(10) Pub. No.: US 2016/0268674 A1
(43) Pub. Date: Sep. 15, 2016

(54) ANTENNA DEVICE AND ELECTRONIC APPARAUS

(71) Applicant: DEXERIALS CORPORATION, Shinagawa-ku, Tokyo (JP)

(72) Inventor: Katsuhisa ORIHARA, Utsunomiya-shi, Tochigi (JP)

(73) Assignee: Dexerials Corporation, Shinagawa-ku, Tokyo (JP)

(21) Appl. No.: 15/033,696

(22) PCT Filed: Nov. 6, 2014
(86) PCT No.: PCT/JP2014/005589

§ 371 Date: May 2, 2016

(30) Foreign Application Priority Data
Nov. 11, 2013 (JP) 2013-233000

(51) Int. Cl. H01Q 1/24; H01Q 1/52; H01Q 7/06

(52) U.S. Cl. CPC H01Q 1/243; H01Q 7/06; H01Q 1/526

(57) ABSTRACT

An antenna device and an electronic apparatus are provided that enable a smaller casing and more stable communication by effectively using a magnetic shielding effect of a metal plate, regardless of internal structure or relationship of other components in a mobile apparatus. An antenna coil (12) is positioned at an edge of an aperture (111) provided in a cover (110) that functions as a magnetic shield of the electronic apparatus and is disposed at an inner wall surface of the cover (110).

### CROSS-REFERENCE TO RELATED APPLICATION

This application claims priority of Japanese Patent Application No. 2013-233000 (filed on Nov. 11, 2013), the entire disclosure of which is incorporated herein by reference.

### TECHNICAL FIELD

The present disclosure relates to an antenna device that is incorporated into an electronic apparatus and that is configured to communicate with an external device via an electromagnetic field signal, and to the electronic apparatus into which the antenna device is incorporated.

### BACKGROUND

Antenna modules for RFID (Radio Frequency Identification) are for example conventionally used in order to provide an electronic apparatus such as a mobile telephone, a smart phone, or a tablet PC with a short-distance contactless communication function.

An antenna module such as described above communicates through inductive coupling with an antenna coil mounted in a transmitter such as a reader/writer. In other words, an antenna coil of the antenna device can receive a magnetic field from the reader/writer and convert the magnetic field to electricity to drive an IC that functions as a communication processor.

In order for the antenna module to communicate reliably, it is necessary for the antenna coil to receive magnetic flux of at least a certain value from the reader/writer. Therefore, in a conventional example of such an antenna device, a loop coil is provided in a casing of a mobile telephone and the loop coil receives magnetic flux from a reader/writer.

However, when an antenna module is incorporated into an electronic apparatus such as a mobile telephone, metal included in a substrate, battery pack, or the like within the electronic apparatus also receives a magnetic field from a reader/writer, leading to production of an eddy current and bouncing back of magnetic flux transmitted from the reader/writer. For example, with regards to the surface of a casing of a mobile telephone, a magnetic field from a reader/writer tends to become stronger at the periphery of the casing surface and tends to become weaker near the center of the casing surface.

In the case of an antenna in which a normal loop coil is used, an aperture of the loop coil is positioned in a central section of the mobile telephone where it is not possible to substantially receive the magnetic field passing through the periphery of the casing surface described above. Consequently, an antenna in which a normal loop coil is used has poor magnetic field reception efficiency.

Antenna devices that have been proposed in consideration of this include an antenna device in which a loop antenna is disposed at the periphery of a casing surface at which a magnetic field from a reader/writer is strong and an antenna device in which a magnetic sheet is used to increase magnetic flux and improve performance. In such antenna devices, the loop antenna has a rectangular shape and is disposed with long sides thereof along peripheral edges of the casing surface (for example, refer to PTL 1-3).

### CITATION LIST

### Patent Literature

PTL 1: JP4883125

PTL 2: JP4894945

PTL 3: JP5135450

### SUMMARY

### Technical Problem

One example of an antenna device that uses a magnetic field shielding effect of metal to improve efficiency is proposed by the applicant of the present application in Japanese Patent Application No. 2013-021616. The antenna device includes a first metal plate disposed inside a casing of an electronic apparatus and opposing an external device, an antenna coil disposed inside the casing of the electronic apparatus and configured to inductively couple with the external device, and a sheet-shaped second metal foil disposed inside the casing of the electronic apparatus such as to overlap with or be in contact with the first metal plate and overlap with at least part of a surface of the antenna coil at an opposite side of the antenna coil to a surface that faces the external device.

In the antenna device described above that uses a magnetic field shielding effect of metal to improve efficiency, the mounting position of the antenna coil is important because the magnetic field shielding effect of metal can be used to improve efficiency by mounting the antenna coil at a position near an edge of a metal plate.

However, in the case of a mobile apparatus, the edge of a metal plate typically coincides with the edge of the mobile apparatus due to the internal structure of the mobile apparatus and securing a mounting position for an antenna coil is problematic due to the relationship with other components.

In light of the conventional problems such as described above, an objective of the present disclosure is to provide an antenna device and an electronic apparatus that enable a smaller casing and more stable communication by effectively using a magnetic shielding effect of a metal plate, regardless of internal structure or relationship of other components in a mobile apparatus.

Other objectives of the present disclosure and specific advantages obtained through the present disclosure should become further apparent from the following explanation of embodiments.

### Solution to Problem

An antenna device according to the present disclosure is incorporated into an electronic apparatus and is configured to communicate with an external device via an electromagnetic field signal. The antenna device includes an antenna coil positioned at an edge of an aperture provided in a cover that functions as a magnetic shield of the electronic apparatus and disposed at an inner wall surface of the cover.

In an electronic apparatus according to the present disclosure, an antenna device is incorporated that is configured to communicate with an external device via an electromagnetic field signal. The electronic apparatus includes a cover in which an aperture is provided and that functions as a magnetic shield, an antenna device including an antenna coil that is positioned at an edge of the aperture and disposed at an inner wall surface of the cover, and a communication processor that is configured to communicate with the external device.

In the electronic apparatus according to the present disclosure, a closed loop formed by a section of the cover disposed around the aperture may be severed by a slit.

In the electronic apparatus according to the present disclosure, the cover may for example be made from a metal that functions as a magnetic shield.

Moreover, in the electronic apparatus according to the present disclosure, the cover may for example include an affixed metal sheet that functions as a magnetic shield.

### BRIEF DESCRIPTION OF THE DRAWINGS

In the accompanying drawings:

FIG. 1 is a perspective view illustrating an overview of configuration of a wireless communication system to which the present disclosure is applied;

FIG. 2 is a perspective view illustrating an antenna substrate and a metal plate in the wireless communication system;

FIG. 3 is a perspective view illustrating an example of the inside of an electronic apparatus in the wireless communication system in a situation in which a metal cover affixed to the inside of a casing is used as a first conductor;

FIG. 4 is a perspective view illustrating an example of the inside of the electronic apparatus in the wireless communication system in a situation in which a metal casing of a battery pack is used as a first conductor;

FIG. 5 is a perspective view illustrating an example of the inside of the electronic apparatus in the wireless communication system in a situation in which a metal plate on a rear surface of a liquid-crystal module is used as a first conductor;

FIG. 6A is a perspective view illustrating an antenna device incorporated into the electronic apparatus;

FIG. 6B is a side view, each illustrating an antenna device incorporated into the electronic apparatus;

FIG. 7 is a perspective view illustrating a state in which a metal foil overlaps with one side of an antenna substrate over the whole length in a longitudinal direction;

FIG. 8 is a perspective view schematically illustrating an example of configuration of an antenna device to which the present disclosure is applied;

FIG. 9 is a longitudinal side view schematically illustrating the main aspects of configuration of the antenna device;

FIG. 10A is a cross-sectional view illustrating a state in which a magnetic sheet is disposed such as to oppose one side section of an antenna coil;

FIG. 10B is a cross-sectional view illustrating a state in which the magnetic sheet is disposed such as to oppose another side section of the antenna coil;

FIG. 11A is a perspective view schematically illustrating a modified example of the antenna device; and

FIG. 11B is a plan view schematically illustrating a modified example of the antenna device.

### DETAILED DESCRIPTION

The following provides a detailed description of embodiments of the present disclosure with reference to the drawings. It should be noted that the present disclosure is not limited to the following embodiments and various alterations may of course be made without deviating from the essence of the present disclosure. Moreover, the drawings are schematic and the ratios of dimensions in the drawings may differ from the actual ratios. Specific dimensions and the like should be determined in light of the following description. Furthermore, the relationship between dimensions and the ratio thereof may of course differ between drawings.

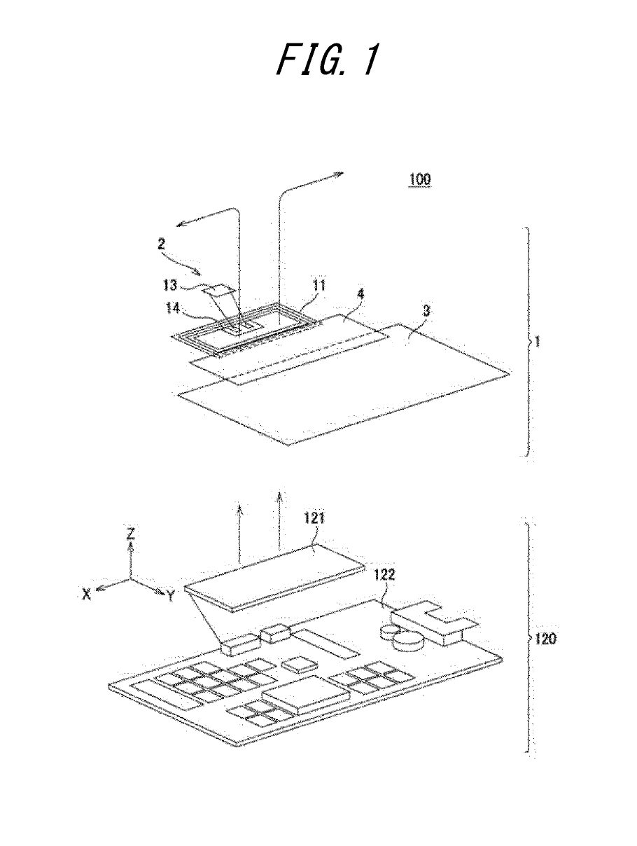

An antenna device to which the present disclosure is applied is incorporated into an electronic apparatus and is configured to communicate with an external device via a magnetic field signal. For example, the antenna device may be incorporated into a wireless communication system 100 for RFID (Radio Frequency Identification) such as illustrated in FIG. 1.

The wireless communication system 100 includes an antenna device 1 and a reader/writer 120 that accesses the antenna device 1. Herein, it is assumed that the antenna device 1 and the reader/writer 120 are arranged so as to oppose each other in the XY plane of a three-dimensional orthogonal coordinate system XYZ.

The reader/writer 120 functions as a transmitter configured to transmit a magnetic field in a Z axis direction with respect to the antenna device 1 opposing the reader/writer 120 in the XY plane. Specifically, the reader/writer 120 includes an antenna 121 configured to transmit a magnetic field to the antenna device 1 and a control substrate 122 configured to communicate with the antenna device 1 by inductive coupling through the antenna 121.

In other words, the reader/writer 120 is provided with the control substrate 122, which is electrically connected to the antenna 121. On this control substrate 122, a control circuit including one or more electronic components such as integrated circuit chips is mounted. The control circuit performs various kinds of processing based on data received from the antenna device 1. For example, when transmitting data to the antenna device 1, the control circuit encodes the data, modulates a carrier wave of a predetermined frequency (for example, 13.56 MHz) based on the encoded data, amplifies the modulated signal, and drives the antenna 121 with the amplified modulated signal. Furthermore, when reading out data from the antenna device 1, the control circuit amplifies a modulated signal of data received by the antenna 121, demodulates the amplified modulated signal of the data, and decodes the demodulated data. The control circuit uses an encoding scheme and a modulation scheme that are employed in common reader/writers, such as Manchester encoding and ASK (Amplitude Shift Keying) modulation.

It should be noted that although the following explanation is provided for the antenna device and so forth in the wireless communication system 100, it goes without saying that the present disclosure can be applied in the same way to a contactless charging system such as a Qi (Chee) system.

The antenna device 1 is incorporated inside a casing of an electronic apparatus, such as a mobile telephone, that is arranged so as to oppose the reader/writer 120 in the XY plane during communication. The antenna device 1 includes an antenna module 2 that is incorporated inside the casing of the electronic apparatus and that is configured to communicate with the inductively coupled reader/writer 120, a metal plate 3 forming a first conductor that is disposed inside the casing of the electronic apparatus and that opposes the reader/writer 120, and a metal foil 4 forming a sheet-shaped second conductor disposed inside the casing of the electronic apparatus that overlaps with or is in contact with the metal plate 3 and that overlaps with at least part of a surface of a loop antenna 11 of the antenna module 2 that is at an opposite side of the loop antenna 11 to a surface facing the reader/writer 120.

The antenna module 2 includes the loop antenna 11 that can communicate with the inductively coupled reader/writer 120 and a communication processor 13 that is driven by current flowing in the loop antenna 11 and communicates with the reader/writer 120.

The loop antenna 11 includes an antenna coil 12 that is for example formed through a patterning process of a flexible, conductive wire, such as a flexible flat cable, and a terminal 14 that electrically connects the antenna coil 12 and the communication processor 13.

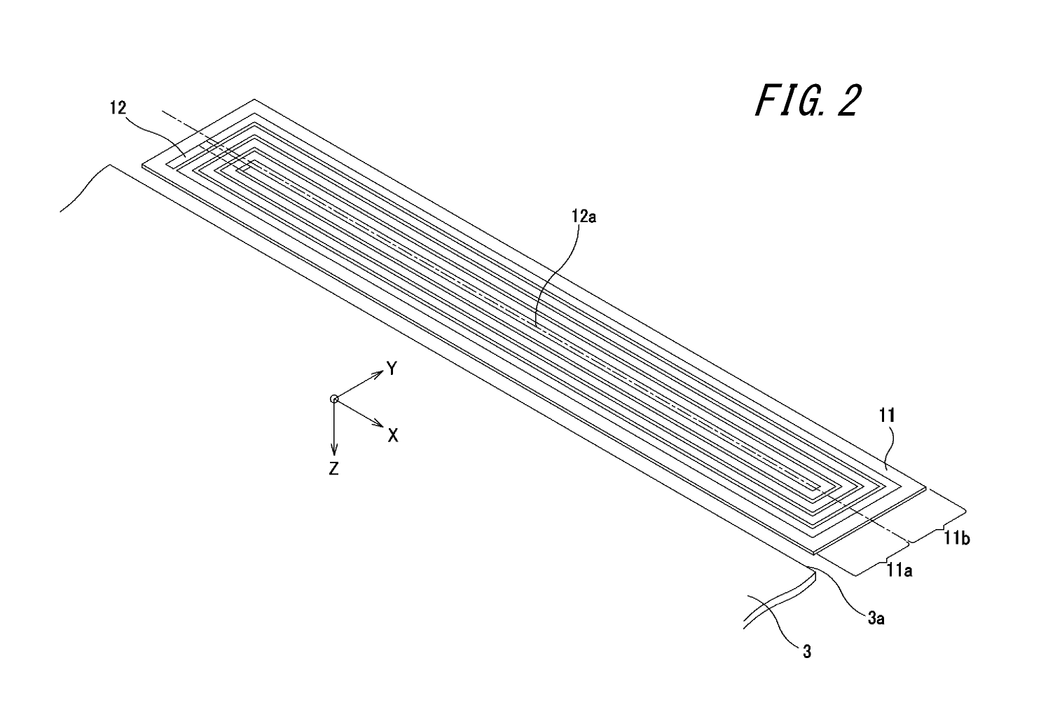

Herein, configuration of the antenna device 1 is explained for a basic structure in which the loop antenna 11 has a roughly rectangular shape and a single conductive wire of the antenna coil 12 loops along the outline thereof, as illustrated in FIG. 2.

A main surface of the loop antenna 11 on which the antenna coil 12 loops around is arranged so as to face the reader/writer 120 in the XY plane during communication. Moreover, the loop antenna 11 includes one side section 11a in which the conductive wire of the antenna coil 12 loops in the same direction as a direction in which current flows longitudinally and another side section 11b in which the conductive wire of the antenna coil 12 loops in an opposite direction to a direction in which current flows longitudinally. A central section 12a of the antenna coil 12 forms a boundary between the one side section 11a and the other side section 11b of the loop antenna 11. The loop antenna 11 is disposed with one longitudinal edge thereof oriented toward the metal plate 3. In other words, the loop antenna 11 is disposed with the one side section 11a or the other side section 11b oriented toward the metal plate 3.

Upon receiving a magnetic field transmitted from the reader/writer 120, the loop antenna 11 becomes magnetically coupled to the reader/writer 120 by inductive coupling, receives a modulated electromagnetic wave, and provides a received signal to the communication processor 13 via the terminal.

The communication processor 13 is driven by current flowing in the loop antenna 11 and communicates with the reader/writer 120. More specifically, the communication processor 13 demodulates the modulated signal that is received, decodes the demodulated data, and writes the decoded data into internal memory of the communication processor 13. Furthermore, the communication processor 13 reads out data from the internal memory to be transmitted to the reader/writer 120, encodes the read-out data, modulates a carrier wave based on the encoded data, and transmits a modulated radio wave to the reader/writer 120 via the loop antenna 11, which is magnetically coupled to the reader/writer 120 through inductive coupling.

Note that the communication processor 13 may alternatively be driven by electricity supplied from an electricity supply means such an external power supply or a battery pack incorporated into the electronic apparatus, instead of by electricity flowing in the loop antenna 11.

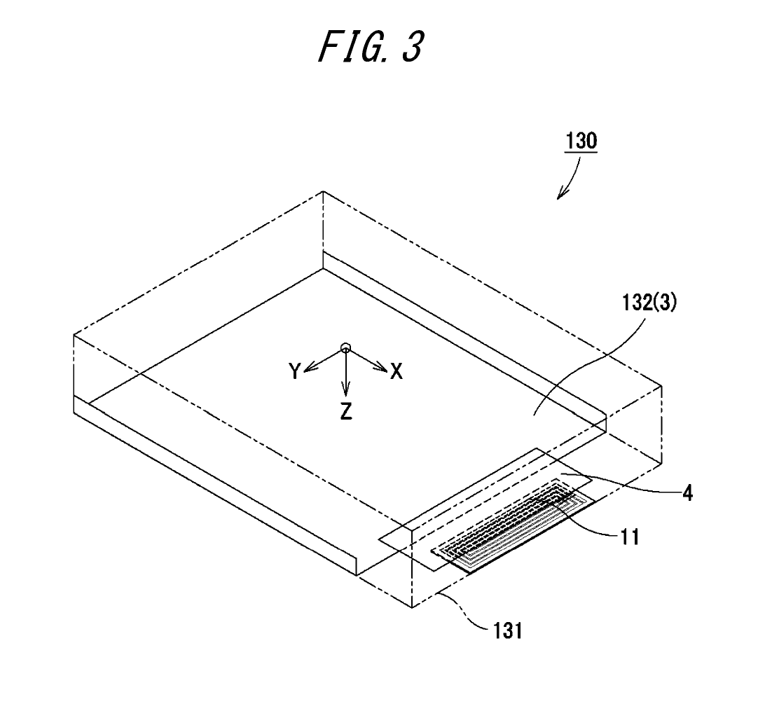

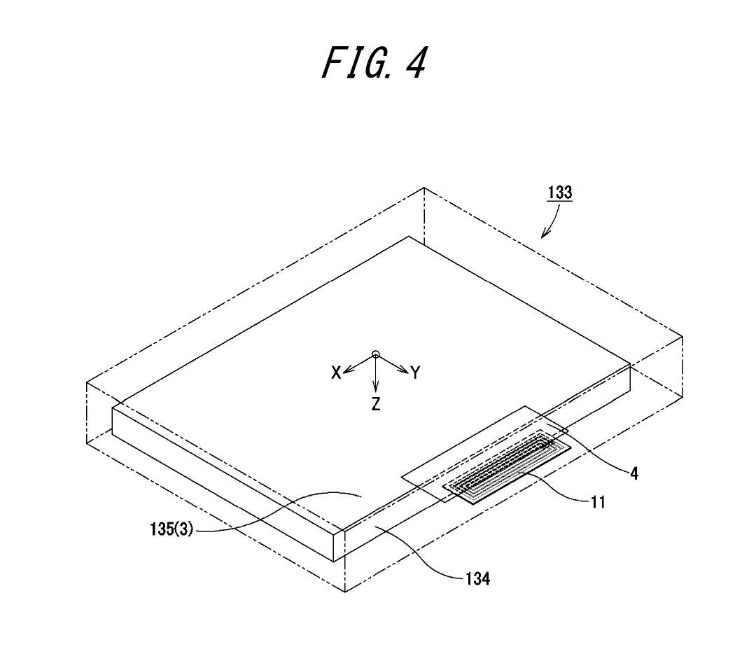

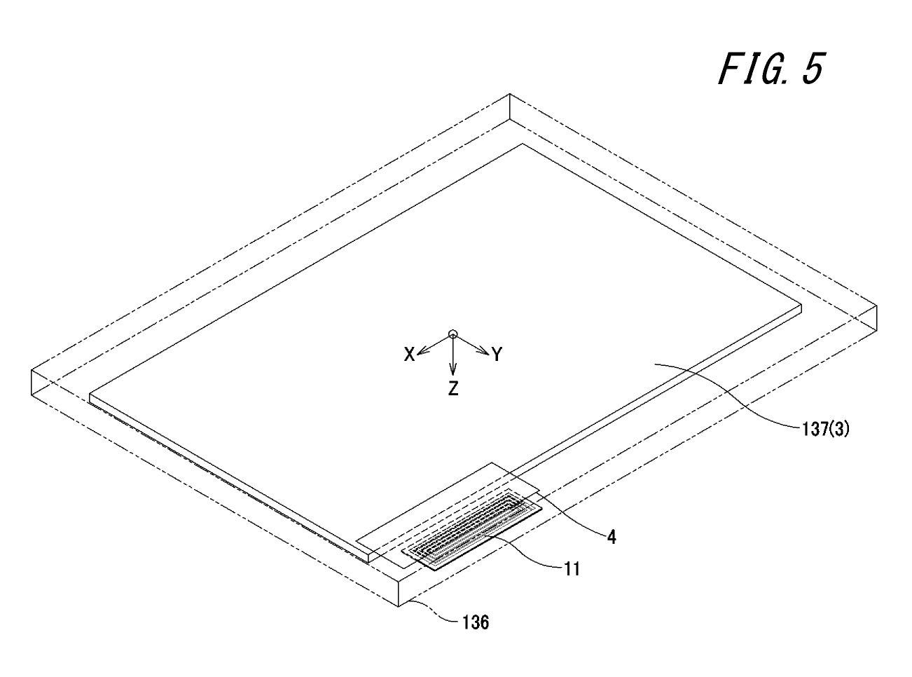

The metal plate 3 for example forms a first conductor that is disposed in the casing of the electronic apparatus, which is for example a mobile telephone, a smart phone, or a tablet PC, and that opposes the reader/writer 120 during communication by the antenna module 2. The first conductor for example corresponds to a metal cover 132 affixed to an inner surface of a casing 131 of a smart phone 130 as illustrated in FIG. 3, a metal casing 135 of a battery pack 134 housed in a smart phone 133 as illustrated in FIG. 4, or a metal plate 137 disposed on a rear surface of a liquid-crystal module in a tablet PC 136 as illustrated in FIG. 5. The following explanation mainly uses the smart phone 133 as an example of the electronic apparatus in order to explain a configuration in which the metal plate 3 forming the first conductor is a main surface of the metal casing 135 of the battery pack 134 housed in the smart phone 133 and the main surface faces the reader/writer 120 during communication.

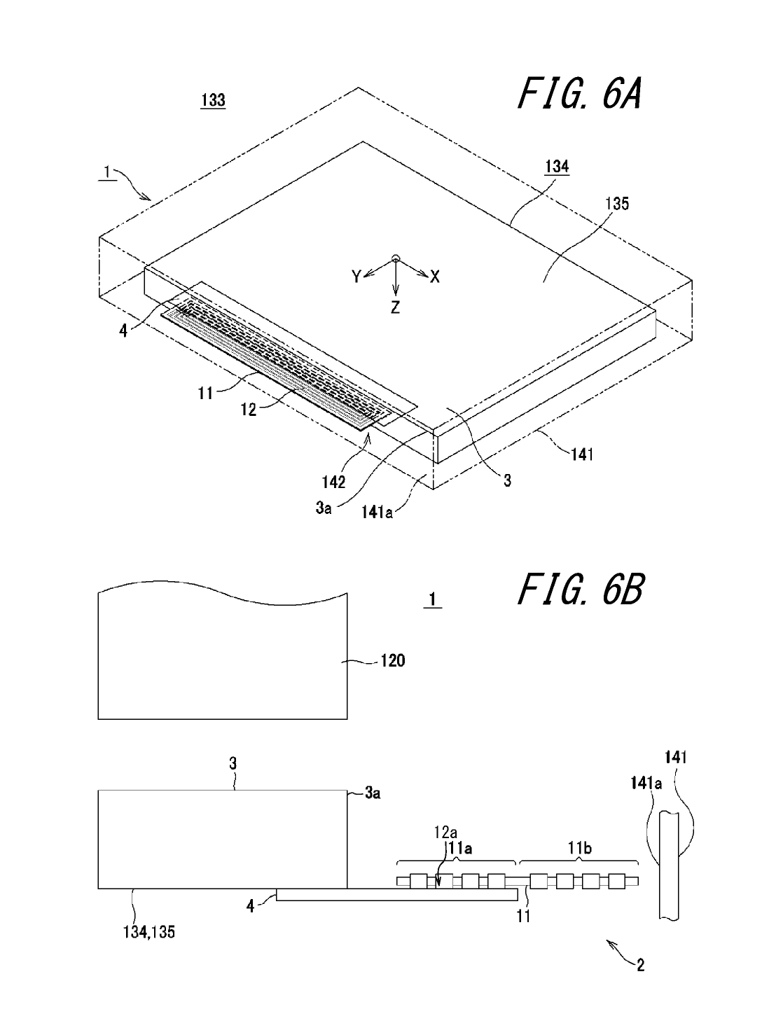

In a situation in which the loop antenna 11 of the antenna module 2 is incorporated into the smart phone 133, in order to enable reduction in size of the smart phone 133 while also achieving favorable communication characteristics with the reader/writer 120, the loop antenna 11 is for example disposed in a space 142 between the battery pack 134 disposed inside of an outer casing 141 of the smart phone 133 and an inner perimeter wall 141a of the outer casing 141 in an XY plane of a three-dimensional orthogonal coordinate system XYZ such as illustrated in FIG. 6A. Specifically, the loop antenna 11 is disposed, as illustrated in FIG. 6B, between the inner perimeter wall 141a of the outer casing 141 and an edge 3a of the metal plate 3 of the metal casing 135 of the battery pack 134 that opposes the reader/writer 120.

Herein, as illustrated in the cross-sectional view in FIG. 6B, the metal plate 3 that forms the metal casing of the battery pack 134 in the smart phone 133 allows electricity to flow relatively easily and consequently an eddy current is produced when an alternating current magnetic field is applied from externally thereto, which causes bouncing back of the magnetic field. Upon investigation of the magnetic field distribution when an alternating current magnetic field is applied from externally as described above, a characteristic of the magnetic field distribution is that the magnetic field is strong at the edge 3a of the metal plate 3 of the battery pack 134 opposing the reader/writer 120.

In order to use a magnetic field strength characteristic inside of the casing 131 of the smart phone 130 such as described above to achieve favorable communication characteristics, the central section 12a, which is parallel to the Z axis as illustrated in FIG. 2, is disposed so as to pass through the space 142 between the edge 3a of the metal plate 3 and the inner perimeter wall 141a of the outer casing 141, and one longitudinal edge is oriented toward the edge 3a of the metal plate 3; in other words, the one side section 11a is oriented toward the edge 3a of the metal plate 3.

In such a configuration, the loop antenna 11 may be disposed at a separated position so as not to be in contact with the edge 3a of the metal plate 3. In a situation in which there is separation between metal plate 3 and the loop antenna 11 as described above due to layout restrictions in the casing of the electronic apparatus, the antenna device 1 can obtain favorable communication characteristics by having the metal foil 4 overlap across the metal plate 3 and the loop antenna 11.

However, note that the loop antenna 11 may be in contact with the metal plate 3. Moreover, the loop antenna 11 may overlap with the metal plate 3. In such a situation, the loop antenna 11 is preferably disposed such that the one side section 11a overlapped by the metal foil 4 described further below overlaps with the metal plate 3, but such that the other side section 11b does not overlap with the metal plate 3. Overlapping of the other side section 11b and the metal plate 3 may actually inhibit inductive coupling of the other side section 11b with magnetic flux of the reader/writer 120.

The metal foil 4 forms a sheet-shaped second conductor disposed between the loop antenna 11 and the metal plate 3 that overlaps with or is in contact with the metal plate 3 (first conductor) and that overlaps with at least part of a surface of the loop antenna 11 that is at an opposite side of the loop antenna 11 to a surface facing the reader/writer 120. The metal foil 4 improves communication performance by overlapping with part of the loop antenna 11 such that the magnetic field is bounced back in the overlapping part of the loop antenna 11 to inhibit inductive coupling in an overlapping region and promote convergence of magnetic flux in a non-overlapping region.

More specifically, magnetic flux from the reader/writer that passes through the loop antenna 11 generates current in opposite directions in the one side section 11a at which the conductive wire of the coil loops in one direction and in the other side section 11b at which the conductive wire of the coil loops in the other direction and, as a result, cannot cause efficient coupling.

Therefore, as a result of the metal foil 4 overlapping with part of the surface of the loop antenna 11 at the opposite side of the loop antenna 11 to the surface facing the reader/writer 120, the antenna device 1 can bounce back the magnetic field in the overlapping region to inhibit inductive coupling in the overlapping region so that current generated in the non-overlapping region can be efficiently transmitted. Furthermore, as a result of the metal foil 4 overlapping with part of the surface of the loop antenna 11 at the opposite side of the loop antenna 11 to the surface facing the reader/writer 120, the antenna device 1 can cause magnetic flux to converge in the non-overlapping region so as to promote efficient electricity generation in the non-overlapping region.

Furthermore, as a result of the metal foil 4 also overlapping with or being in contact with the metal plate 3, the antenna device 1 can guide magnetic flux from the metal plate 3, without leakage, to the region of the loop antenna 11 that is not overlapped by the metal foil 4 and can therefore achieve more efficient inductive coupling. Moreover, as a result of the metal foil 4 overlapping with the metal plate 3, the antenna device 1 can prevent generation of current by inductive coupling in the part overlapped by the metal foil 4 due to leaked magnetic flux from the metal plate 3.

It is preferable, but not essential, that the metal foil 4 is a good conductor such as a copper foil. The thickness of the metal foil 4 is determined as appropriate in accordance with a communication frequency of the antenna device 1 and the reader/writer 120. For example, the metal foil 4 may be a metal foil of from 20 μm to 30 μm in thickness when the communication frequency is 13.56 MHz.

Note that so long as the metal foil 4 overlaps with the metal plate 3 and the loop antenna 11, it is not necessary for the metal foil 4 to be in contact therewith. However, it is advantageous in terms of coupling coefficient for the metal foil 4 to be closer to the metal plate 3 and the loop antenna 11; therefore, the metal foil 4 is preferably close to or in contact with the metal plate 3 and the loop antenna 11.

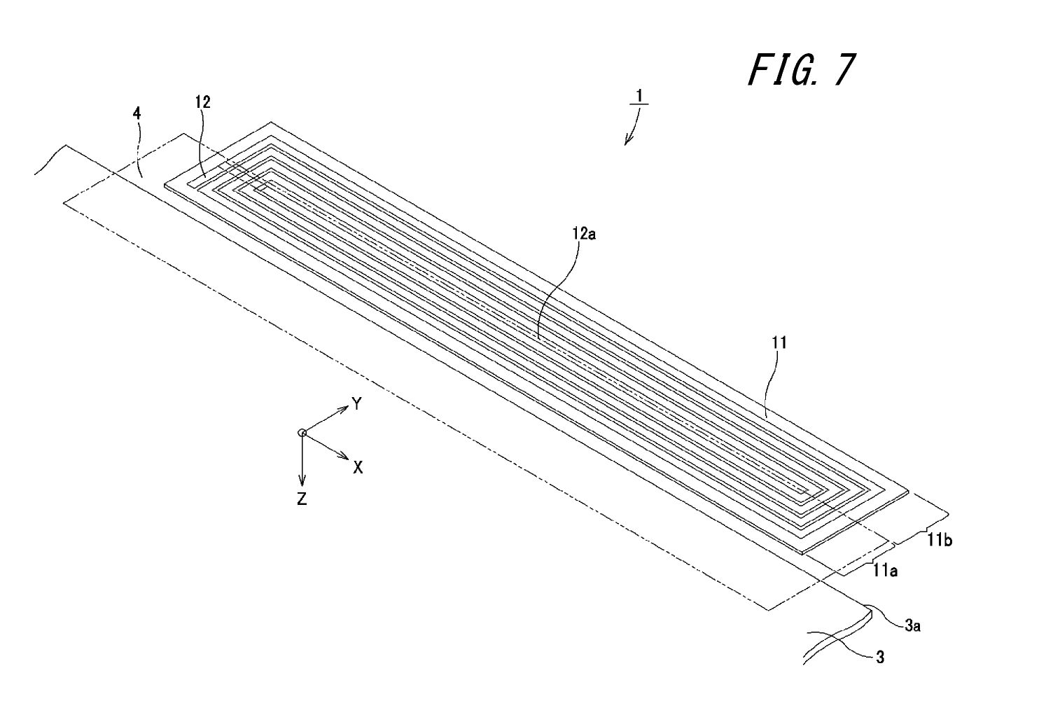

The metal foil 4 preferably overlaps from an edge of the one side section 11a of the loop antenna 11 to the central section 12a of the antenna coil 12 as illustrated in FIG. 7. By overlapping as described above, the metal foil 4 can improve communication characteristics by inhibiting coupling in the one side section 11a of the loop antenna 11 to keep the amount of current in an opposite direction to current generated in the other side section 11b relatively small, while also guiding magnetic flux from the one side section 11a to the other side section 11b of the loop antenna 11 so as to promote coupling in the other side section 11b.

As illustrated in FIG. 7, the metal foil 4 is preferably at least as long as the one side section 11a of the loop antenna 11 in the longitudinal direction and preferably overlaps with the one side section 11a of the loop antenna 11 over the entire length of the one side section 11a in the longitudinal direction. By overlapping as described above, the metal foil 4 can improve communication characteristics by inhibiting inductive coupling in the one side section 11a of the loop antenna 11 to keep the amount of current in an opposite direction to current generated in the other side section 11b relatively small, while also guiding magnetic flux from the one side section 11a to the other side section 11b of the loop antenna 11 so as to promote coupling in the other side section 11b.

In the preceding explanation, a configuration of the antenna device 1 in the wireless communication system 100 is explained for a basic structure in which the loop antenna 11 has a roughly rectangular shape and the conductive wire of the antenna coil 12 loops along the outline thereof as illustrated in FIG. 2. The antenna coil 12 of the antenna device 1 to which the present disclosure is applied is positioned at an edge of an aperture 111 provided in a cover 110 that functions as a magnetic shield of the electronic apparatus and disposed at an inner wall surface of the cover 110.

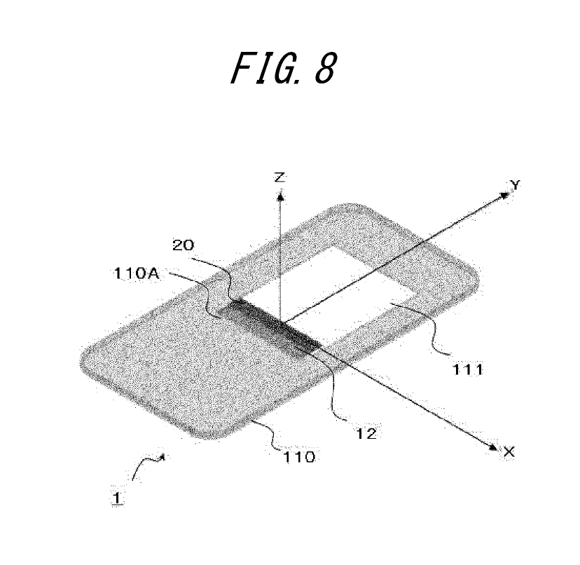

Specifically, as illustrated in FIG. 8, the antenna coil 12 of the loop antenna 11 in the antenna device 1 to which the present disclosure is applied is for example positioned at an edge 110A of an aperture 111, which is for example used for a liquid-crystal display section, provided in a cover 110 made from a metal that functions as a magnetic shield of an electronic apparatus such as the smart phone 130 and is disposed at an inner wall surface of the cover 110.

The cover 110 may include an affixed metal sheet that functions as a magnetic shield.

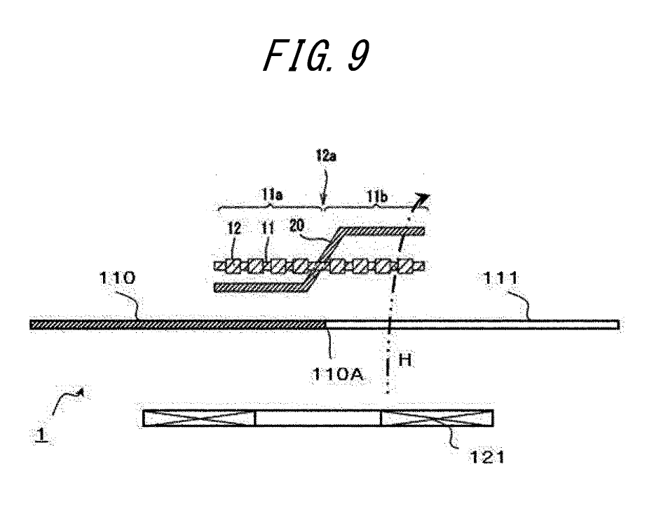

As a result of the antenna coil 12 being disposed at the inner wall surface of the cover 110 with the central section 12a thereof positioned at the edge 110A of the aperture 111 provided in the cover 110 functioning as the magnetic shield as illustrated in FIG. 9, the antenna coil 12 is bisected into the one side section 11a and the other side section 11b of the loop antenna 11 at the periphery of the aperture 111 such that the one side section 11a of the loop antenna 11 opposes the cover 110 made from the metal functioning as the magnetic shield and the other side section 11b of the loop antenna 11 opposes the aperture 111 in the cover 110.

In the antenna device 1 described above including the antenna coil 12 positioned at the edge 110A of the aperture 111 provided in the cover 110 of the electronic apparatus and disposed at the inner wall surface of the cover 110, a magnetic field H transmitted from the antenna 121 of the reader/writer 120 is reliably pulled into the cover 110 made from the metal functioning as the magnetic shield, via a central aperture of the antenna coil 12, as illustrated in FIG. 9.

In the loop antenna 11 illustrated in FIG. 9, a magnetic sheet 20 is inserted into the central aperture of the antenna coil 12. In other words, the magnetic sheet 20 is inserted into the central aperture in the central section 12a of the antenna coil 12 such that at the one side section 11a of the loop antenna 11, the antenna coil 12 is closer than the magnetic sheet 20 to the reader/writer 120 and at the other side section 11b of the loop antenna 11, the magnetic sheet 20 is closer than the antenna coil 12 to the reader/writer 120.

The loop antenna 11 has a structure in which the central aperture extends in the longitudinal direction in the central section 12a of the antenna coil 12 and the magnetic sheet 20 is inserted into the central aperture. In other words, the magnetic sheet 20 is inserted into the central section 12a of the antenna coil 12, which is formed on a printed substrate, such that the antenna coil 12 and the magnetic sheet 20 overlap one another to satisfy two positional requirements: a positional requirement that at a side corresponding to the cover 110 functioning as the magnetic shield, the magnetic sheet 20 is positioned between the antenna coil 12 and the cover 110 and opposing the one side section 11a of the antenna coil 12; and a positional requirement that at a side corresponding to the central aperture opposing the reader/writer 120, the magnetic sheet 20 is positioned closer than the antenna coil 12 to the reader/writer 120 and opposing the other side section 11b of the antenna coil 12.

Inserting the magnetic sheet 20 into the central aperture of the antenna coil 12 as described above can improve communication characteristics by further improving efficiency of pulling in the magnetic field H transmitted from the antenna 121 such that a large electromotive force is generated in the antenna coil 12 through the guided magnetic field.

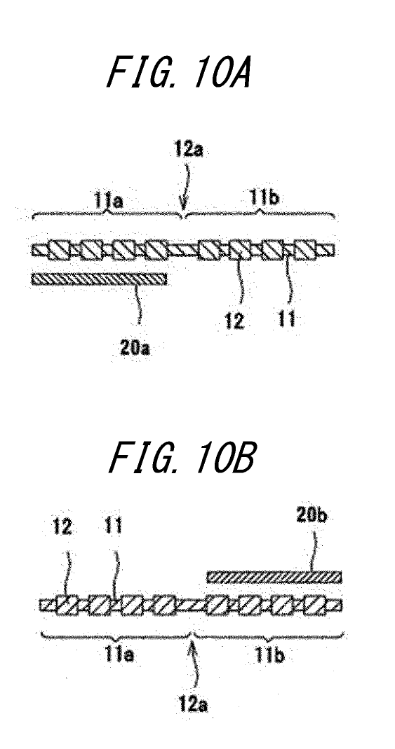

Note that the magnetic field H transmitted from the antenna 121 can be efficiently pulled into the antenna coil 12 and communication characteristics can be improved even in a structure that includes, instead of the magnetic sheet 20 inserted into the central aperture of the antenna coil 12, a magnetic sheet 20a that is disposed between the antenna coil 12 and the cover 110 functioning as the magnetic shield and opposing the one side section 11a of the antenna coil 12 as illustrated in FIG. 10A, or a magnetic sheet 20b that is disposed closer than the antenna coil 12 to the reader/writer 120 and opposing the other side section 11b of the antenna coil 12 as illustrated in FIG. 10B.

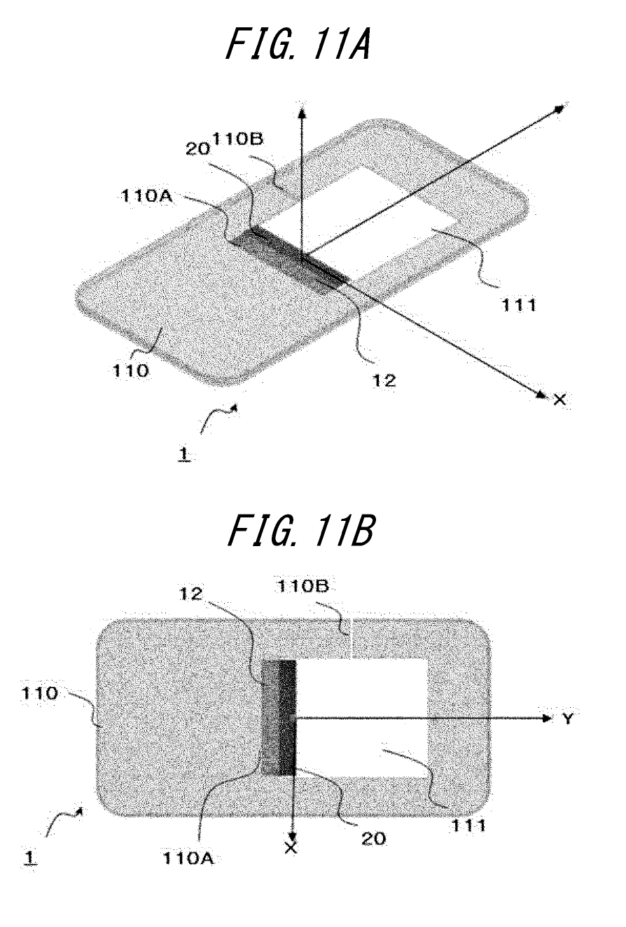

In an electronic apparatus, such as the smart phone 130, including the antenna device 1 to which the present disclosure is applied, a section of the cover 110 made from the metal functioning as the magnetic shield that is disposed around the aperture 111 forms a closed loop functioning as a one turn coil that responds to magnetic flux passing through the aperture 111, which reduces electromotive force in the antenna coil 12. However, it is possible to prevent the section disposed around the aperture 111 from functioning as a one turn coil by providing a slit 110B that severs the closed loop formed by the section disposed around the aperture 111 as illustrated in FIGS. 11A and 11B.

In other words, by providing the slit 110B to sever the closed loop formed by the section disposed around the aperture 111, the magnetic field H transmitted from the antenna 121 of the reader/writer 120 can be reliably pulled into the cover 110 made from the metal functioning as the magnetic shield, via the central aperture of the antenna coil 12, and a large electromotive force can be generated in the antenna coil 12 through the guided magnetic field to improve communication characteristics.

### REFERENCE SIGNS LIST

1 antenna device
2 antenna module
3 metal plate
4 metal foil
11 antenna substrate
12 antenna coil
13 communication processor
14 terminal
20 magnetic sheet
21A, 21B loop antenna wireless communication system
110 cover
110A edge
110B slit
111 aperture
120 reader/writer
121 antenna
141 outer casing
141a inner perimeter wall
142 space

1. An antenna device that is incorporated into an electronic apparatus and that is configured to communicate with an external device via an electromagnetic field signal, the antenna device comprising
an antenna coil positioned at an edge of an aperture provided in a cover that functions as a magnetic shield of the electronic apparatus and disposed at an inner wall surface of the cover.

2. An electronic apparatus into which an antenna device is incorporated that is configured to communicate with an external device via an electromagnetic field signal, the electronic apparatus comprising:
a cover in which an aperture is provided and that functions as a magnetic shield;
an antenna device including an antenna coil that is positioned at an edge of the aperture and disposed at an inner wall surface of the cover; and
a communication processor configured to communicate with the external device.

3. The electronic apparatus of claim 2, wherein
a closed loop formed by a section of the cover disposed around the aperture is severed by a slit.

4. The electronic apparatus of claim 2, wherein
the cover is made from a metal that functions as a magnetic shield.

5. The electronic apparatus of claim 2, wherein
the cover includes an affixed metal sheet that functions as a magnetic shield.

6. The electronic apparatus of claim 3, wherein
the cover is made from a metal that functions as a magnetic shield.

7. The electronic apparatus of claim 3, wherein
the cover includes an affixed metal sheet that functions as a magnetic shield.
